(19) United States
(12) Patent Application Publication
(10) Pub. No.: US 2016/0349876 A1
(43) Pub. Date: Dec. 1, 2016

(54) TOUCH DISPLAY PANEL AND TOUCH DISPLAY APPARATUS

(71) Applicants: BOE TECHNOLOGY GROUP CO., LTD., Beijing (CN); CHENGDU BOE OPTOELECTRONICS TECHOLOGY CO., LTD, Chengdu, Sichuan (CN)

(72) Inventors: Yue Long, Beijing (CN); Weijing Huang, Beijing (CN); Yang Wang, Beijing (CN); Tingliang Liu, Beijing (CN)

(21) Appl. No.: 14/912,853

(22) PCT Filed: May 29, 2015
(86) PCT No.: PCT/CN2015/080240

§ 371 Date: Feb. 18, 2016

(30) Foreign Application Priority Data
Jan. 26, 2015 (CN) 201510038442.X

(51) Int. Cl. G06F 3/044

(52) U.S. Cl. CPC G06F 3/044

(57) ABSTRACT

A touch display panel includes at least one strip-shaped electrode region and at least one spacing region which are alternately arranged. Each strip-shaped electrode region comprises a plurality of strip-shaped signal lines arranged side by side, each spacing region comprises a plurality of spacers arranged side by side, and, each signal line and each spacer have substantially the same width.

### CROSS-REFERENCE TO RELATED APPLICATIONS

This application is a Section 371 National Stage Application of International Application No. PCT/CN2015/080240, filed 29 May 2015, entitled “TOUCH DISPLAY PANEL AND TOUCH DISPLAY APPARATUS”, which claims priority to Chinese Application No. 201510038442.X, filed on Jan. 26, 2015, incorporated herein by reference in their entirety.

### BACKGROUND

1. Technical Field

Embodiments of the present invention relate to the field of display technology, and particularly to a touch display apparatus having a touch display panel.

2. Description of the Related Art

In a conventional hybrid in-cell type touch screen, a transmit (Tx) electrode is integrated inside a liquid crystal cell and a receive (Rx) electrode, in the form of a tin indium oxide (ITO) sensor, is disposed outside the liquid crystal cell. Specifically, the Rx electrode generally includes two parts in layout design. One of the two parts is a strip-shaped electrode (prong) region while the other is a spacing (dummy) region. The strip-shaped electrode region consists of a plurality of electrode signal lines, runs through an entire effective touch area, and is responsible for feeding back a signal to a touch integrated circuit (IC). The spacing region is composed of an independent ITO wiring, and a main function of the spacing region is to enhance an electric field signal. In addition, the spacing region also has an electrostatic prevention effect and can also cooperate with a pattern of the strip-shaped electrode region to improve a visual effect. In addition, a single Rx electrode may include a plurality of strip-shaped electrode regions and a plurality of spacing regions, in its layout design. The plurality of spacing regions are not connected to one another, and the strip-shaped electrode regions and the spacing regions are not connected to one another. Furthermore, in the conventional layout design of the Rx electrode, the plurality of strip-shaped electrode regions are alternately arranged with the plurality of spacing regions.

However, in the conventional layout design of the Rx electrode, the strip-shaped electrode region and the spacing region match themselves or do not match each other, in shape factors such as a width and a pitch, thereby resulting in visible stripe of a touch pattern design on a touch display panel. For example, FIGS. 1-3 show a layout design of an Rx electrode in a conventional touch display panel. FIG. 1 shows a displaying effect of an entire effective touch area in a conventional design. Vertical stripe can be relatively apparently seen from FIG. 1. FIG. 2 is a detailed diagram of a portion indicated by 10 at an upper end of the touch pattern design in FIG. 1. FIG. 3 is a detailed diagram of a portion indicated by 20 at a lower end of the touch pattern design in FIG. 1. In FIGS. 2 and 3, a strip-shaped electrode region is indicated by 31 and is mainly composed of ITO strip-shaped electrodes, and a spacing region is indicated by 32 and is mainly formed of an array of many small rectangular ITO spacers. In addition, referring to FIG. 3, a lower end of the strip-shaped electrode region 31 is provided with a signal terminal 33 for connection to a flexible printed circuit board (FPC) for a touch screen or to an IC for a touch screen. As can be known from FIGS. 2-3, in the conventional layout design of the Rx electrode, each strip-shaped electrode region has a relatively large width, and a pitch between adjacent ones of the strip-shaped electrode regions is N times as large as a dot pitch; and the spacer in each spacing region has a relatively small line width and a pitch between adjacent ones of the spacers is the dot pitch. The inventors of the present application find that, it is because in the conventional layout design, a strip-shaped electrode of the strip-shaped electrode region and the spacer of the spacing region match themselves or do not match each other, in shape factors such as the width and the pitch, accordingly, the stripe of the touch pattern design on the touch display panel is caused to be visible and thus the visual effect is adversely affected.

### SUMMARY

Embodiments of the present invention provide a touch display panel comprising at least one strip-shaped electrode region and at least one spacing region which are alternately arranged, wherein: each strip-shaped electrode region comprises a plurality of strip-shaped signal lines arranged side by side, each spacing region comprises a plurality of spacers arranged side by side, each signal line and each spacer have substantially the same width, and a pitch between adjacent ones of the signal lines in each strip-shaped electrode region and a pitch between adjacent ones of the spacers in each spacing region are substantially the same.

Here, “each signal line and each spacer have substantially the same width” may mean that a difference between a width of the signal line and a width of the spacer is not greater than 10%, and “a pitch between adjacent ones of the signal lines in each strip-shaped electrode region and a pitch between adjacent ones of the spacers in each spacing region are substantially the same” may mean that a difference between the pitch between the adjacent ones of the signal lines in each strip-shaped electrode region and the pitch between the adjacent ones of the spacers in each spacing region is not greater than 10%.

Embodiments of the present invention provide a touch display device comprising the abovementioned touch display panel.

### BRIEF DESCRIPTION OF THE DRAWINGS

In order that the above and other objects, advantages, and features of the present invention become more apparent and are more readily appreciated, a further description of the present invention will be made as below with reference to embodiments of the present invention taken in conjunction with the accompanying drawings.

FIG. 1 is a diagram showing a displaying effect of an entire effective touch area in a conventional touch display panel;

FIG. 2 is a detailed diagram of a portion indicated by 10 at an upper end of a conventional touch pattern in FIG. 1;

FIG. 3 is a detailed diagram of a portion indicated by 20 at a lower end of the conventional touch pattern in FIG. 1;

FIG. 4 is a diagram showing a displaying effect of an entire effective touch area in a touch display panel according to a first embodiment of the present invention;

FIG. 5 is a detailed diagram of a portion indicated by A at an upper end of a touch pattern in FIG. 4;

FIG. 6 is a detailed diagram of a portion indicated by B at a lower end of the touch pattern in FIG. 4;

FIG. 7 is a detailed diagram of a portion at an upper end of an entire touch pattern of a touch display panel according to a second embodiment of the present invention; and

FIG. 8 is a detailed diagram of a portion at a lower end of the entire touch pattern of the touch display panel according to the second embodiment of the present invention.

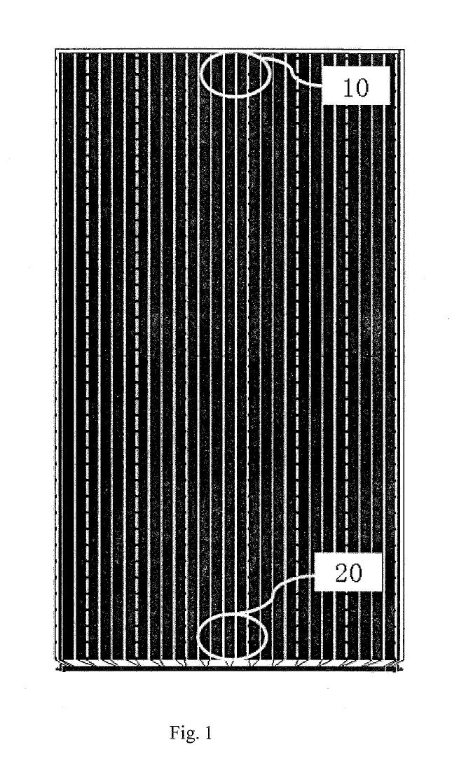

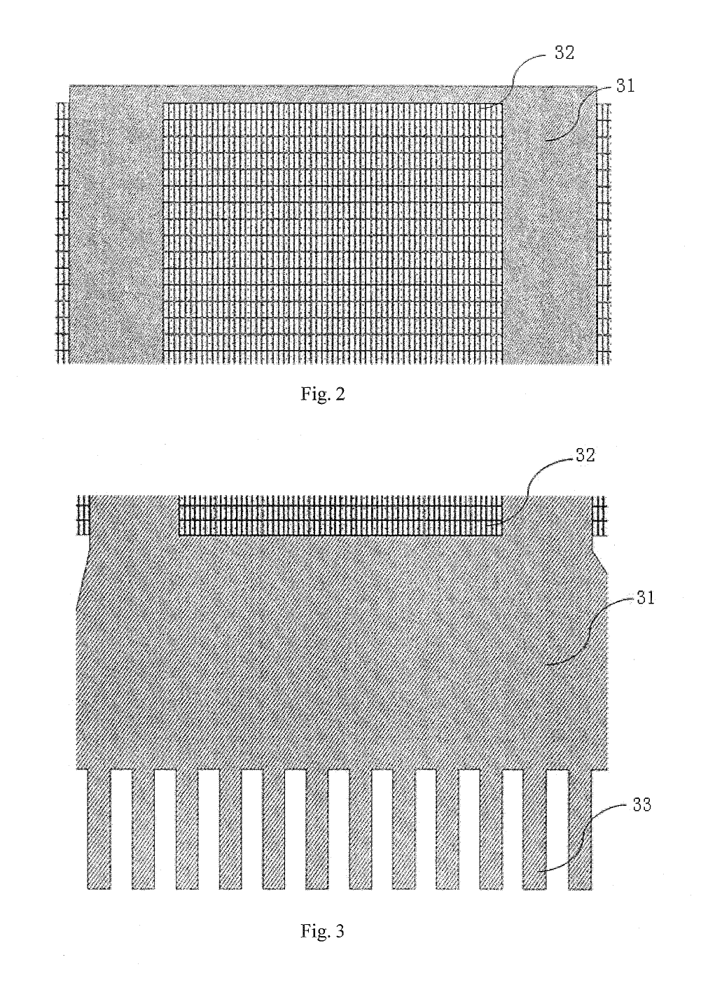

### DETAILED DESCRIPTION OF THE EMBODIMENTS

Reference will now be made in detail to the specific embodiments of the present invention, examples of which are illustrated in the accompanying drawings, wherein like reference numerals refer to like elements throughout. The specific embodiments described below with reference to the accompany drawings are illustrative, are intended to explain the present invention, and should not be construed to limit the present invention.

The technical solutions of embodiments of the present invention will be described by taking a hybrid in-cell type touch display panel as an example in the embodiments. Of course, the technical solutions according to the embodiments of the present invention can also be applied to various other capacitive type touch display panels.

According to embodiments of the present invention, a touch display device comprises the touch display panel. Embodiments of the present invention will be described as follows in detail in conjunction with the accompanying drawings.

### First Embodiment

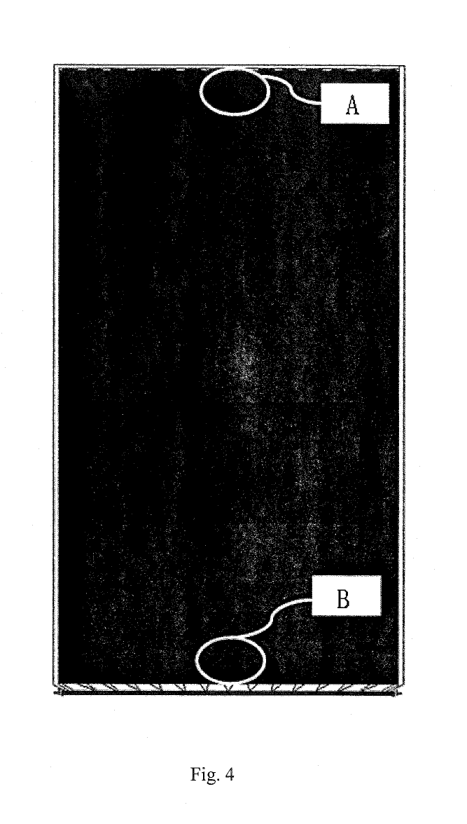

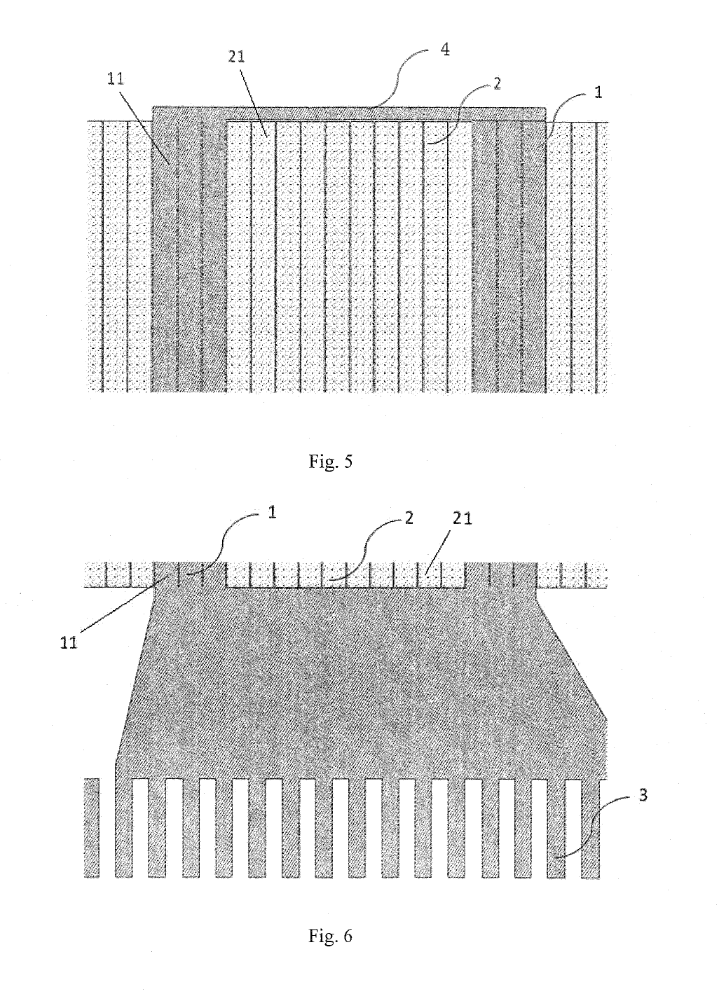

FIG. 4 is a diagram showing a displaying effect of an entire effective touch area in a touch display panel according to a first embodiment of the present invention; FIG. 5 is a detailed diagram of a portion indicated by A at an upper end of a touch pattern in FIG. 4; and FIG. 6 is a detailed diagram of a portion indicated by B at a lower end of the touch pattern in FIG. 4.

In the first embodiment as shown in FIGS. 4-6, the touch display panel comprises Rx electrodes, and each Rx electrode has a strip-shaped electrode region 1 and a spacing region 2. In the present embodiment, each Rx electrode has a plurality of strip-shaped electrode regions 1 and a plurality of spacing regions 2. Of course, in other embodiments, each Rx electrode may have one or more strip-shaped electrode regions and one or more spacing regions. Specifically, the touch display panel comprises a plurality of strip-shaped electrode regions 1 and a plurality of spacing regions 2, which are alternately arranged. Each strip-shaped electrode region 1 comprises a plurality of strip-shaped signal lines 11, such as ITO strip-shaped signal lines 11, arranged side by side, and each spacing region 2 comprises a plurality of strip-shaped spacers 21, such as ITO strip-shaped spacers 21, arranged side by side. Each signal line 11 and each spacer 21 have substantially the same width, and a pitch between adjacent ones of the signal lines 11 in each strip-shaped electrode region 1 and a pitch between adjacent ones of the spacers 21 in each spacing region 2 are substantially the same, and for example, may be both about an integral multiple of a pitch between sub-pixel units (not shown) or an integral multiple of a pitch between pixels of pixel units (not shown) in the touch display panel. The pitch between the adjacent ones of the signal lines 11 is a sum of a width of one of the signal lines 11 and a width of a gap between the one signal line 11 and another one of the signal lines 11 which is adjacent to the one signal line 11, and the pitch between the adjacent ones of the spacers 21 is a sum of a width of one of the spacers 21 and a width of a gap between the one spacer 21 and another one of the spacers 21 which is adjacent to the one spacer 21.

In the present embodiment, as shown in FIGS. 5 and 6, the plurality of strip-shaped electrode regions 1 and the plurality of spacing regions 2 are alternately arranged side by side and are arranged throughout within an effective touch area, and the signal lines 11 in each strip-shaped electrode region 1 and the spacers 21 in each spacing region 2 all have a strip shape. Furthermore, these strip-shaped electrode regions 1 (and their signal lines 11) are connected to one another, to play a signal feedback role; and the spacing regions 2 (and their spacers 21) mainly play an electric field enhancing role. The spacing regions 2 (and their spacers 21) also have an electrostatic prevention effect and can also cooperate with a pattern of the strip-shaped electrode regions to improve a visual effect. Furthermore, each spacing region 2 (and its spacers 21) is independent. The plurality of spacing regions 2 (and their spacers 21) are not connected to one another. In other words, each spacing region 2 (and its spacers 21) is connected to neither an adjacent one of the strip-shaped electrode regions 1 (and its signal lines 11) nor another adjacent one of the spacing regions 2 (and its spacers 21).

In the present embodiment, as shown in FIG. 5, the plurality of strip-shaped electrode regions 1 are connected to one another through a wiring 4, such as a metal wiring, arranged at a periphery of the strip-shaped electrode regions 1 and the spacing regions 2, thereby achieving a feedback signal transmission. In addition, as shown in FIG. 6, the plurality of strip-shaped electrode regions 1 also have one same signal terminal 3. The signal terminal 3 will be connected to a flexible printed circuit board (FPC) for a touch screen or to an IC for a touch screen, thereby feeding back a signal to the latter.

As described above, in the touch display panel according to the present embodiment, the strip-shaped signal lines in the strip-shaped electrode regions and the spacers in the spacing regions have substantially the same width, and the pitch between adjacent ones of the signal lines in each strip-shaped electrode region and the pitch between adjacent ones of the spacers in each spacing region are substantially the same, so that the strip-shaped electrode regions and the spacing regions can match each other, to achieve a good stripe eliminating effect, thereby improving a visual effect.

### Second Embodiment

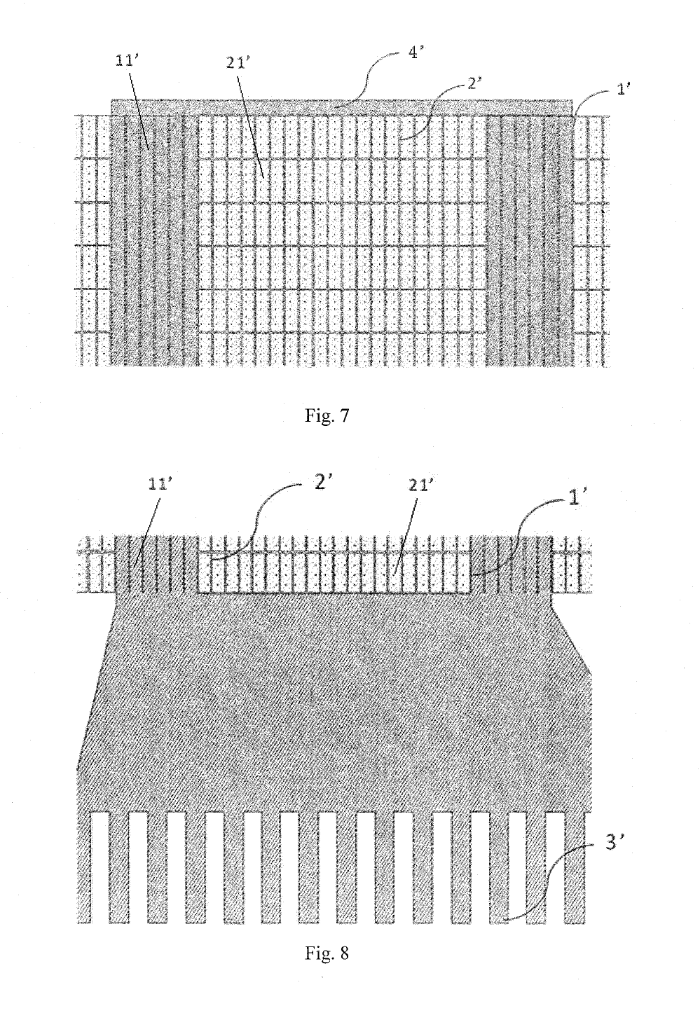

FIG. 7 is a detailed diagram of a portion at an upper end of an entire touch pattern of a touch display panel according to a second embodiment of the present invention; and FIG. 8 is a detailed diagram of a portion at a lower end of the entire touch pattern of the touch display panel according to the second embodiment of the present invention.

In the second embodiment as shown in FIGS. 7-8, the touch display panel comprises Rx electrodes, and each Rx electrode has a strip-shaped electrode region 1′ and a spacing region 2′. In the present embodiment, each Rx electrode has a plurality of strip-shaped electrode regions 1′ and a plurality of spacing regions 2′. Of course, in other embodiments, each Rx electrode may have one or more strip-shaped electrode regions and one or more spacing regions. Specifically, the touch display panel comprises strip-shaped electrode regions 1′ and spacing regions 2′, which are alternately arranged. Each strip-shaped electrode region 1′ comprises a plurality of strip-shaped signal lines 11′, such as ITO signal lines 11′, arranged side by side, and each spacing region 2′ comprises a plurality of rectangular spacers 21′, such as ITO spacers 21′, arranged side by side. Each signal line 11′ and each spacer 21′ have substantially the same width, and a pitch between adjacent ones of the signal lines 11′ in each strip-shaped electrode region 1′ and a pitch between adjacent ones of the spacers 21′ in each spacing region 2′ are substantially the same, and for example, may be both about an integral multiple of a pitch between sub-pixel units (not shown) or an integral multiple of a pitch between pixels of pixel units (not shown) in the touch display panel. The pitch between the adjacent ones of the signal lines 11′ is a sum of a width of one of the signal lines 11′ and a width of a gap between the one signal line 11′ and another one of the signal lines 11′ which is adjacent to the one signal line 11′, and the pitch between the adjacent ones of the rectangular spacers 21′ is a sum of a width of one of the spacers 21′ and a width of a gap between the one spacer 21′ and another one of the spacers 21′ which is adjacent to the one spacer 21′.

In the present embodiment, as shown in FIGS. 7 and 8, the plurality of strip-shaped electrode regions 1′ and the plurality of spacing regions 2′ are alternately arranged side by side and are arranged throughout within an effective touch area, and the signal line 11′ in each strip-shaped electrode region 1′ has a strip shape, and the spacer 21′ in each spacing region 2′ has a rectangular shape. Specifically, as shown in FIGS. 7 and 8, each spacing region 2′ is composed of a rectangular ITO spacer array. In addition, a length of each rectangular spacer 21′ may be about an integral multiple of a pitch between sub-pixel units or an integral multiple of a pitch between pixels of pixel units in the touch display panel.

In the present embodiment, these strip-shaped electrode regions 1′ (and their signal lines 11′) are connected to one another, to play a signal feedback role; and the spacing regions 2′ (and their spacers 21′) play an electric field enhancing role. The spacing regions 2′ (and their spacers 21′) also have an electrostatic prevention effect and can also cooperate with a pattern of the strip-shaped electrode regions to improve a visual effect. Furthermore, each spacing region 2′ (and its spacers 21′) is independent. The plurality of spacing regions 2′ (and their spacers 21′) are not connected to one another. In other words, each spacing region 2′ (and its spacers 21′) is connected to neither an adjacent one of the strip-shaped electrode regions 1′ (and its signal lines 11′) nor another adjacent one of the spacing regions 2′ (and its spacers 21′).

In the present embodiment, as shown in FIG. 7, the plurality of strip-shaped electrode regions 1′ are connected to one another through a wiring 4′, such as a metal wiring, arranged at a periphery of the strip-shaped electrode regions 1′ and the spacing regions 2′, thereby achieving a feedback signal transmission. In addition, as shown in FIG. 8, the plurality of strip-shaped electrode regions 1′ also have one same signal terminal 3′. The signal terminal 3′ will be connected to a flexible printed circuit board (FPC) for a touch screen or to an IC for a touch screen, thereby feeding back a signal to the latter.

According to the embodiments of the present invention, the strip-shaped electrode regions run throughout an entire effective touch area, and the strip-shaped signal lines in the strip-shaped electrode regions are connected through the signal terminal to the flexible printed circuit board (FPC) for the touch screen or to the IC for the touch screen, thereby feeding back the signal to the latter. The spacers in the spacing regions may have the rectangular shape or a strip shape similar to that of the strip-shaped signal lines in the strip-shaped electrode regions. These spacing regions are filled between the strip-shaped electrode regions within the effective touch area, to play an electric field enhancing role. In addition, these spacing regions also have an electrostatic prevention effect and can also cooperate with the pattern of the strip-shaped electrode regions to improve the visual effect.

As described above, in the touch display panel and the touch display apparatus according to the embodiments of the present invention, the shapes of the strip-shaped electrode regions and the spacing regions of the Rx electrode in layout design are changed. In other words, line widths of both the strip-shaped signal lines in the strip-shaped electrode regions and the spacers in the spacing regions tend to be consistent with each other. In addition, the pitch between adjacent ones of the signal lines in each strip-shaped electrode region and the pitch between adjacent ones of the spacers in each spacing region are substantially the same. As a result, the strip-shaped electrode regions and the spacing regions can match each other to achieve a good stripe eliminating effect, thereby improving the visual effect.

The above embodiments are only used to explain the present invention, and should not be construed to limit the present invention. It will be understood by those skilled in the art that various changes and modifications may be made therein without departing from the spirit of the present invention, the scope of which is defined in the appended claims and their equivalents. Apparently, it will be understood by those skilled in the art that various changes, modifications, substitutions and alterations may be made.

1. A touch display panel comprising:
at least one strip-shaped electrode region and at least one spacing region which are alternately arranged, wherein: each strip-shaped electrode region comprises a plurality of strip-shaped signal lines arranged side by side, each spacing region comprises a plurality of spacers arranged side by side, each signal line and each spacer have substantially the same width, and a pitch between adjacent ones of the signal lines in each strip-shaped electrode region and a pitch between adjacent ones of the spacers in each spacing region are substantially the same.

2. The touch display panel of claim 1, wherein:
both the pitch between the adjacent ones of the signal lines in each strip-shaped electrode region and the pitch between the adjacent ones of the spacers in each spacing region are about an integral multiple of a pitch between sub-pixel units in the touch display panel.

3. The touch display panel of claim 1, wherein:
the pitch between the adjacent ones of the signal lines is a sum of a width of one of the signal lines and a width of a gap between the one signal line and another one of the signal lines which is adjacent to the one signal line, and the pitch between the adjacent ones of the spacers is a sum of a width of one of the spacers and a width of a gap between the one spacer and another one of the spacers which is adjacent to the one spacer.

4. The touch display panel of claim 1, wherein:
the spacers each have a strip shape.

5. The touch display panel of claim 1, wherein:
the spacers each have a rectangular shape.

6. The touch display panel of claim 5, wherein:
a length of each spacer is about an integral multiple of a pitch between sub-pixel units in the touch display panel.

7. The touch display panel of claim 5, wherein:
each spacing region is composed of a spacer array.

8. The touch display panel of claim 1, wherein:
the spacers are made of ITO.

9. The touch display panel of claim 1, wherein:
the at least one strip-shaped electrode region comprises a plurality of strip-shaped electrode regions, the at least one spacing region comprises a plurality of spacing regions, and the plurality of strip-shaped electrode regions are connected to one another through a wiring arranged at a periphery of the plurality of strip-shaped electrode regions and the plurality of spacing regions.

10. The touch display panel of claim 9, wherein:
the plurality of strip-shaped electrode regions have one same signal terminal.

11. The touch display panel of claim 1, wherein:
the at least one spacing region comprises a plurality of spacing regions, and the plurality of spacing regions are not connected to one another.

12. The touch display panel of claim 1, wherein:
the touch display panel comprises Rx electrodes, and each of the Rx electrodes has the strip-shaped electrode region and the spacing region.

13. The touch display panel of claim 12, wherein:
each of the Rx electrodes has one or more said strip-shaped electrode regions and one or more said spacing regions.

14. A touch display apparatus comprising: the touch display panel of an claim 1.

15. The touch display panel of claim 2, wherein:
the spacers each have a strip shape.

16. The touch display panel of claim 2, wherein:
the spacers each have a rectangular shape.

17. The touch display panel of claim 16, wherein:
a length of each spacer is about an integral multiple of a pitch between the sub-pixel units in the touch display panel.

18. The touch display panel of claim 16, wherein:
each spacing region is composed of a spacer array.

19. The touch display panel of claim 1, wherein:
each spacing region is composed of a spacer array.

20. The touch display panel of claim 2, wherein:
the touch display panel comprises Rx electrodes, and each of the Rx electrodes has the strip-shaped electrode region and the spacing region.
